(19) United States
(12) Patent Application Publication
(10) Pub. No.: US 2014/0065412 A1
(43) Pub. Date: Mar. 6, 2014

(54) DISPERSED NANOPARTICLES IN TRANSPARENT COATINGS

(71) Applicant: NORDKALK OY AB, Pargas (FI)

(72) Inventors: Mathias Snare, Pargas (FI); Juuso Hakala, Pargas (FI)

(73) Assignee: NORDKALK OY AB, Pargas (FI)

(21) Appl. No.: 13/796,861

(22) Filed: Mar. 12, 2013

(30) Foreign Application Priority Data
Sep. 6, 2012 (FI) 20125923

(51) Int. Cl. C09D 7/12; C09D 1/00

(52) U.S. Cl. CPC C09D 7/1266; C09D 1/00
USPC 428/332; 106/286.6; 428/446; 428/432; 428/537.7; 428/537.1

(57) ABSTRACT

The present invention concerns a transparent or semi-transparent coating prepared from coating mixture containing conventional coating components mixed with a coating slurry containing dispersed inorganic nano-particles in a content of 1-70 w-% of the slurry. Further, the invention concerns a manufacturing process of such a coating, as well as a manufacturing process of said coating slurry.

### CROSS REFERENCE TO RELATED APPLICATION

Applicants hereby claim foreign priority benefits under U.S.C. §119 from Finnish Patent Application No. 20125923 filed on Sep. 6, 2012, the contents of which are incorporated by reference herein.

### BACKGROUND OF THE INVENTION

1. Field of the Invention

The present invention concerns transparent or semi-transparent coatings and coating slurries that contain dispersed nanoparticles, as well as processes for the manufacture of these. These coatings are intended to be used on solid products, such as concrete, plastic or glass surfaces, or on fibrous structures, such as the surfaces of paper, wood and furniture products.

2. Description of Related Art

Transparent and semi-transparent coatings are widely used in the paper, wood and furniture coating industry for enhancing surface properties of these products, particularly hardness and gloss.

In non-transparent coatings, fillers are more commonly used in addition to the conventional polymer pigments in order to reduce costs, since polymer pigments are expensive. Nanoparticles have thus been used in coatings in general for various purposes, as in WO 201078071 A1 and in US 2005/0234178 A1. Further, JP 11012497 A relates to the use of colourless microparticles in printing ink.

Such non-transparent coating formulations can contain e.g. nano-sized precipitated calcium carbonate (nano-PCC) as a filler. These formulations have traditionally been manufactured by adding PCC agglomerates into water to a suitable solids content, and mixing thoroughly to provide a fluid consistency, whereafter a drying step is carried out in order to provide a formulation having a higher solids content, which is suitable to be applied on the desired surface to form the coating. However, there is a demand for an improved procedure, since this traditionally used alternative results in a coating formulation that still contains non-dispersed agglomerates, which provide a low transparency.

However, due to the specific requirements of semi-transparent and transparent coatings, and due to the difficulties in dispersing typical filler pigments these coatings are generally formulated with a minimum amount of filler, hence affecting the raw material costs. In fact, in completely transparent applications the aim is to use no fillers.

Particularly in the case of high strength surface applications, which utilize transparent coatings, e.g. in furniture and floor applications, the coating formulation often consists of expensive special polymers enhancing the mechanical properties of the application. Gloss and viscosity of the coatings applied on these products can be adjusted by adding different additives. However, the addition of supplementary components to the coating formulation makes the formulation complex and difficult to handle, which might lead to complex formulations and product inconsistency. Also the transparency is often reduced.

### SUMMARY OF THE INVENTION

It is an object of the present invention to provide a novel transparent or semi-transparent coating for fibrous products, as well as a manufacturing process thereof.

Particularly, it is an object of the present invention to provide such a transparent or semi-transparent coating having a simple composition and providing a high surface strength.

These and other objects, together with the advantages thereof over known coatings and processes, are achieved by the present invention, as hereinafter described and claimed.

The present invention is based on the development of tailored transparent and semi-transparent coatings for use in concrete, plastic, glass or fibrous end-products to provide them with superior mechanical properties and increased filler content.

Thus, the present invention concerns a transparent coating containing dispersed nanoparticles, the coating having been formed from a coating slurry having a high solids content. Further, the invention concerns a manufacturing process of such a coating slurry, as well as the application of the slurry on said product surfaces to provide the final coating.

More specifically, the coating slurry of the present invention contains dispersed inorganic nanoparticles in a content of 1-70 w-% of the slurry, while its manufacturing process in transparent form, has a thickness of ≦150 μm, more preferably 1-80 μm, and most suitably about 60 μm, and in semi-transparent form, has a thickness of ≦450 μm, and most suitably 80-400 μm.

Further, the final coating has been formed from a coating slurry containing inorganic nanoparticles in a content of 1-70 w-% of the slurry, and optional further components, by applying this coating mixture on a surface, while its manufacturing process adding a dispersing agent, preferably prior to any mechanical or ultrasonic treatment.

Considerable advantages are obtained by means of the invention. Thus, the present invention introduces nano-particles evenly and efficiently dispersed in a coating matrix (the slurry) to be formulated into a transparent coating. This gives rise to superior final product properties, simplified formulation as well as higher filler content compared to conventional transparent coatings, thus achieving savings in the cost of the raw material.

Due to a novel procedure for evenly and efficiently dispersing the filler into the slurry, its content can be maximized, thus keeping the particle size below half of the wavelength of visible light and avoiding visible light to be absorbed by the particles. Thereby, the transparency is maintained.

Simultaneously, gloss and viscosity can be optimized via filler addition, as well as an enhanced surface hardness and durability. In optimizing the viscosity and gloss, the thixotropic behavior of the nano-particle slurry can be utilized.

Next, the invention will be described more closely with reference to the attached drawing and a detailed description.

### BRIEF DESCRIPTION OF THE DRAWING

The preferred examples of the invention will now be described in more detail with reference of the drawings, wherein:

FIG. 1 illustrates the opacity of a coating of the present invention on a drawdown card.

FIG. 2 illustrates the König hardness of a coating of the present invention on a glass plate.

FIG. 3 illustrates the König hardness of a preprocessed or in-situ processed coating of the present invention on a glass plate.

FIG. 4 illustrates the gloss of a preprocessed or in-situ processed coating of the present invention on a glass plate.

### DETAILED DESCRIPTION OF THE PREFERRED EMBODIMENTS OF THE INVENTION

The present invention concerns a transparent coating containing nanoparticles that are formed from an inorganic compound.

In said context, the term “transparent” is intended to include also “semi-transparent” coatings, whereby a completely “transparent” coating is considered to be a coating that exhibits a light transmission of >90% (for visible light, at a wavelength of 400-800 nm), and “semi-transparent”, in turn, is used for coatings exhibiting a light transmission of 70-90% (at said wavelengths). Thus, the term “coating” is intended to include also films, lacquers, varnishes, waxes and wood oils. Particularly the water thinnable versions of said coatings are intended.

The transparent coatings can have a thickness of ≦150 μm, preferably 1-80 μm, and most suitably about 60 μm, while the semi-transparent coatings can be made thicker, having a thickness of ≦450 μm, and most suitably 80-400 μm.

The nanoparticles can be formed from various inorganic compounds, particularly those obtainable from mineral sources. Examples include particles of calcium carbonate, silicate or other minerals derivable from clay or mica, preferably being calcium carbonate, more preferably precipitated or ground calcium carbonate (PCC or GCC), and most suitably being PCC. These materials can contain traces of organic compounds, which can also be transferred to the nanoparticles used in the invention. Due to the negligible contents of these organic compounds, the material of the nano-particles is still referred to as inorganic.

The term “nano-particle” is intended to include any particles having a mean particle diameter of less than 1 μm. In the present context, a particle diameter of less than 400 nm is preferred, more preferably 3-300 nm, and most suitably of 5-80 nm, particularly in order to maintain a particle size that is below the wavelength of visible light.

These nanoparticles are generally obtained by the dispersion of agglomerates to separate these into smaller particles. Thus, the present invention also relates to a coating slurry containing said particle dispersion.

Said slurry contains dispersed inorganic nanoparticles in a content of 1-70 w-%, preferably 5-70 w-%, more preferably 20-60 w-%, and most preferably 40-55 w-%, of the slurry.

The slurry can be manufactured by carrying out a mechanical or ultrasonic treatment, or both, on said nanoparticles or their agglomerates at a solids content of 10-100 w-%, preferably 15-65 w-%, whereafter solvent is added to provide a coating slurry containing the dispersed nanoparticles at a desired final solids content of 1-70 w-% of the slurry, preferably 1-50 w-%, more preferably 1-40 w-%, and most suitably 1-20 w-%.

The coating slurry is intended to include any dispersions or mixtures formed using solvents or solutions that are based on either an inorganic or an organic solvent. However, the most preferred solvent is water, whereby the slurry containing the nanoparticles is an aqueous solution, dispersion or mixture.

The coating slurry can further contain additives, such as dispersing agents. These can include, in addition to agents commonly used as dispersing agents, also conventional binders.

The optional dispersing agent is used to facilitate the complete dispersion of the nanoparticles into a suitable solids content, while it is preferred to avoid the use of other additives.

Said optional dispersion agent can be added either on-site to the coating slurry during its manufacture, or off-site during nano-particle production or dispersion of agglomerates, whereby the dispersion agent is added to the coating slurry simultaneously with the dispersed nano-particles.

To form the final coating, a coating slurry, such as the one described above, is generally mixed with optional further coating components, to form a coating mixture, and applied onto a surface. The further coating components include one or more agents selected from the group of binders, dispersing agents, wetting agents, anti-foaming agents, viscosity modifiers and film-forming agents.

The total content of said additives (dispersing agents and optional further coating components) in the final coating is preferably 10-70 w-%, more preferably 30-60 w-%, and most suitably 35-50-%.

The present invention also concerns a process for manufacturing a transparent coating, particularly the above-described final coating. This process includes the step of treating said inorganic nanoparticles to cause their dispersion and forming a slurry, mixing the slurry with optional firther coating components, as well as applying the mixture onto a desired product surface, and optionally separately drying the formed coating.

The above described coatings can be applied on any surfaces, which generally are surfaces of solid products, such as concrete, plastic, glass or fibrous surfaces. However, it is preferred to use these coatings on fibrous solid products, such as paper, wood or furniture. The coating is preferably applied as a uniform coating on at least one surface of said product, whereby the coating will cover the entire surface. The application is then followed by a step of drying to remove the solvent, or at least to remove excess solvent.

The following non-limiting examples are intended merely to illustrate the advantages obtained with the embodiments of the present invention.

### EXAMPLES

### Example 1

A coating formulation was prepared, based on an aqueous slurry containing 50 w-% of nano-sized calcium carbonate having a mean primary particle diameter of 50 nm (based on SEM-images). The nano-particles were dispersed into the aqueous solution using ultrasonic treatment

The coating formulation was applied with film applicator on a glass plate and drawdown card (opacity chart), and dried, to form uniform layer of 30-70 μm thickness

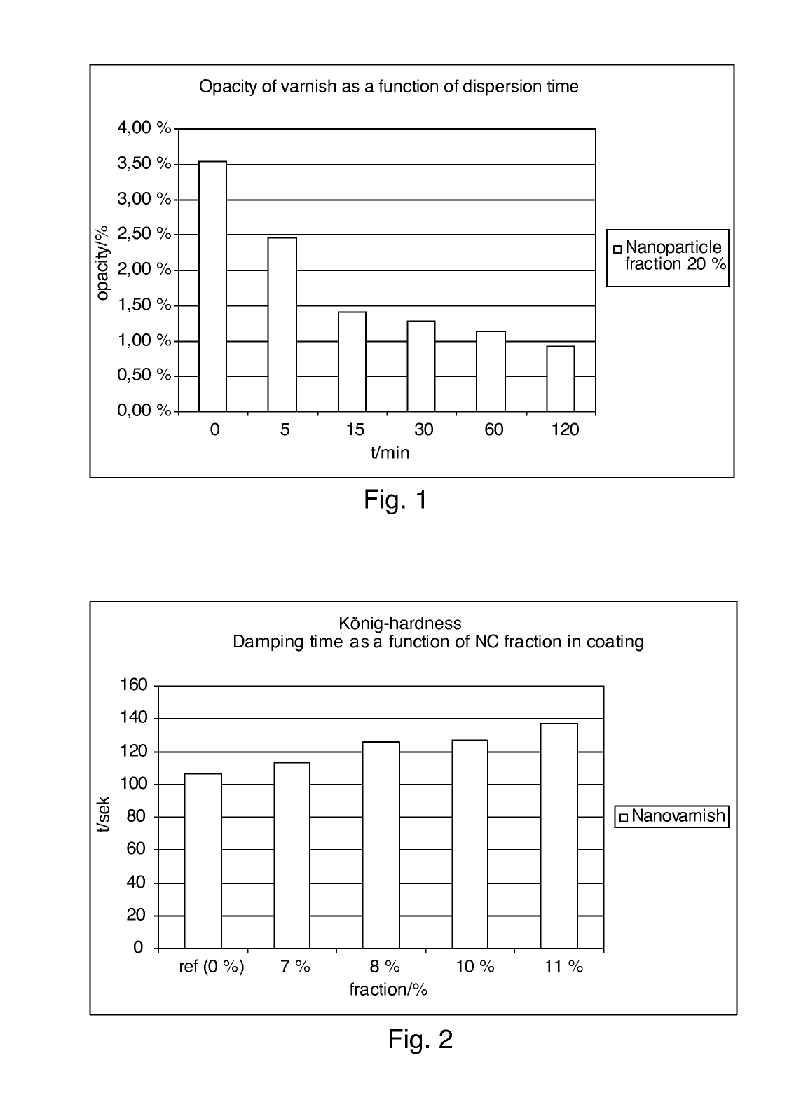

The opacity of the coating on the drawdown card is illustrated in FIG. 1. FIG. 1 shows how transparency of the coating enhances as dispersion time increases.

The König hardness of the coating on the glass plate is illustrated in FIG. 2. FIG. 2 shows how damping time increases as function of increasing nanoparticle fraction of the coating.

### Example 2

Another coating formulation was prepared, based on an aqueous nanoparticle slurry containing 12 w-% of nano-sized calcium carbonate having a mean primary particle diameter of 50 nm. The slurry was predispersed prior to addition to the coating formulation and insitu dispersion in the coating formulation.

The coating formulation was applied as above

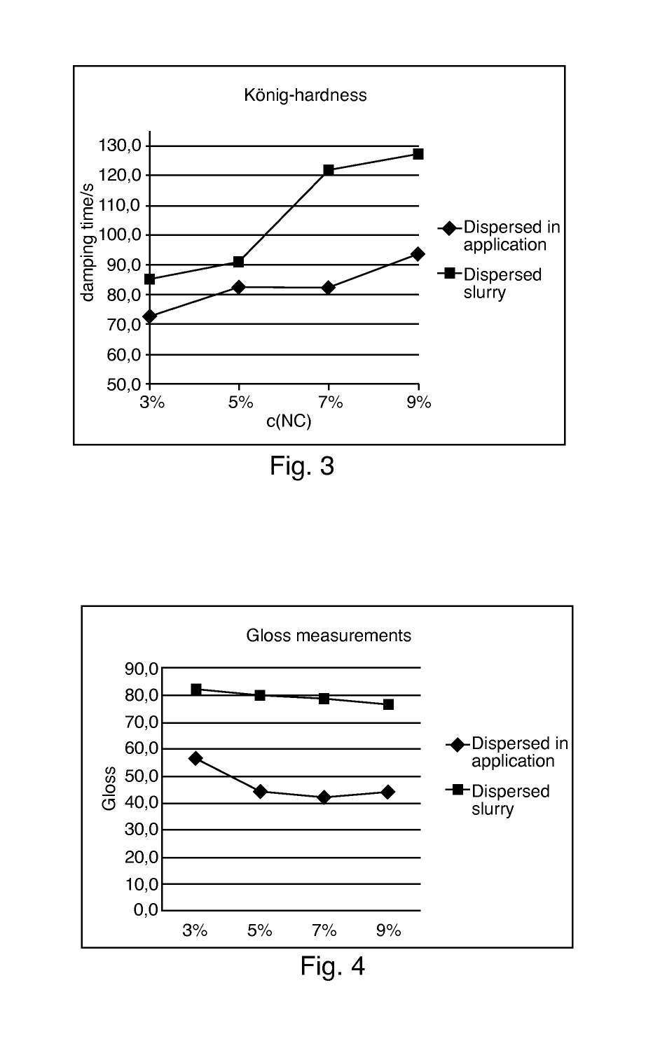

The König hardness and gloss of the coatings are illustrated in FIGS. 3 and 4, respectively.

While the present invention has been illustrated and described with respect to a particular embodiment thereof, it should be appreciated by those of ordinary skill in the art that various modifications to this invention may be made without departing from the spirit and scope of the present.

What is claimed is:

1. A coating slurry containing nanoparticles, wherein it contains dispersed inorganic nanoparticles in a content of 1-70 w-% of the slurry.

2. The coating slurry of claim 1, wherein the nanoparticles are particles of calcium carbonate, silicate or other minerals derivable from clay or mica, preferably being calcium carbonate, more preferably ground or precipitated calcium carbonate (GCC or PCC), most suitably PCC.

3. The coating slurry of claim 1, wherein it contains dispersed inorganic nanoparticles in a content of 5-70 w-%, preferably 20-60 w-%, most preferably 40-55 w-%.

4. The coating slurry of claim 1, wherein it further contains a dispersing agent.

5. A transparent or semi-transparent coating containing nanoparticles, wherein it has been formed from a coating slurry containing inorganic nanoparticles in a content of 1-70 w-% of the slurry, and optional further components, by applying this coating mixture on a surface.

6. The coating of claim 5, wherein it has been formed from a coating mixture containing the coating slurry containing dispersed inorganic nanoparticles in a content of 1-70 w-% of the slurry.

7. The coating of claim 5, wherein said coating mixture further contains one or more agents selected from the group of binders, dispersing agents, wetting agents, anti-foaming agents, viscosity modifiers and film-forming agents.

8. The coating of claim 5, wherein it has been formed by applying the coating mixture on the surface of a solid product, such as a concrete, plastic, glass or fibrous product, the fibrous product preferably being selected from paper, wood or furniture.

9. The coating of claim 5, wherein it, in transparent form, has a thickness of ≦150 μm, more preferably 1-80 μm, and most suitably about 60 um, and in semi-transparent form, has a thickness of ≦450 μm, and most suitably 80-400 μm.

10. A process for manufacturing the coating slurry of claim 1 by dispersion of inorganic nanoparticles, wherein carrying out a mechanical or ultrasonic treatment, or both, on said inorganic nanoparticles or their agglomerates at a solids content of 10-100 w-%, whereafter solvent is added to provide a coating slurry containing the dispersed nanoparticles at a desired final solids content of 1-70 w-% of the slurry.

11. The process of claim 10, wherein adding a dispersing agent, preferably prior to any mechanical or ultrasonic treatment.

12. A process for manufacturing a transparent or semi-transparent coating, wherein mixing the coating slurry according to claim 1 with optional further coating components, and by applying this coating mixture on a surface.

13. The process of claim 12, wherein applying said coating mixture on a solid product, such as a the surface of a concrete, plastic, glass or fibrous product, the fibrous product preferably being selected from paper, wood or furniture.

14. The process of claim 12, wherein applying the coating mixture on the surface using a film applicator.

15. The process of claim 12, wherein carrying out a drying step after the application onto the surface.

16. The coating slurry of claim 2, wherein it contains dispersed inorganic nanoparticles in a content of 5-70 w-%, preferably 20-60 w-%, most preferably 40-55 w-%.

17. The coating slurry of claim 2, wherein it further contains a dispersing agent.

18. The coating slurry of claim 3, wherein it further contains a dispersing agent.

19. The coating according to claim 6, wherein said coating mixture further contains one or more agents selected from the group of binders, dispersing agents, wetting agents, anti-foaming agents, viscosity modifiers and film-forming agents.

20. The coating according to claim 6, wherein it has been formed by applying the coating mixture on the surface of a solid product, such as a concrete, plastic, glass or fibrous product, the fibrous product preferably being selected from paper, wood or furniture.
